(19) United States
(12) Patent Application Publication
(10) Pub. No.: US 2005/0270544 A1
(43) Pub. Date: Dec. 8, 2005

(54) Variable dispersion step-phase interferometers

(75) Inventors: Yung-Chieh Hsieh, San Jose, CA (US); Chiayu Ai, Newark, CA (US); Chih-Hung Chien, Fremont, CA (US)

Correspondence Address: John P. Wooldridge, 252 Kaipii Place, Kihei, HI, 96753, US

(73) Assignee: Optoplex Corporation

(21) Appl. No.: 11/146,614

(22) Filed: Jun. 6, 2005

Related U.S. Application Data
(60) Provisional application No. 60/577,052, filed on Jun. 4, 2004.
(60) Provisional application No. 60/587,312, filed on Jul. 12, 2004.

(51) Int. Cl. G01B 9/02

(52) U.S. Cl. 356/519

(57) ABSTRACT

Optical interferometers with variable dispersion are shown. These interferometers are useful as optical interleavers and through the control of their design, are made to have negative and near-zero dispersion. The N-type interleaver has a negative dispersion slope near the center of the pass band. The Z-type interleaver has a dispersion that is close to zero within the pass band. These interleavers can be arranged in various systems to produce low dispersion optical networks. The non-linear phase etalons in the N- and Z-type interleavers taught herein contribute to the device dispersion. The N-Type interleaver includes a linear cavity length that is 1.5 times that of a non-linear cavity. The Z-type interleaver includes two non-linear cavities that are out of phase with each other such that the net dispersion is close to zero.

This application claims priority to U.S. Provisional Patent Application Ser. No. 60/577,052, filed Jun. 4, 2004, titled: “Negative and Zero Dispersion Step-Phase Interferometer,” incorporated herein by reference.

This application claims priority to U.S. Provisional Patent Application Ser. No. 60/587,312, filed Jul. 11, 2004, titled: “Compact Angle-Tuned Beam Splitter,” incorporated herein by reference.

### BACKGROUND OF THE INVENTION

1. Field of the Invention

The present invention relates to interleaving frequencies in optical communication systems, and more specifically, it relates to controlling dispersion in step-phase interferomters.

2. Description of Related Art

The optical interleaver is a device that enables the fabrication of a fine spacing optical network through coarser filters. For instance, one can build a 50 GHz channel spacing network by combining a 50 GHz/100 GHz interleaver with 100 GHz filters.

There are several ways to build an optical interleaver. Among them, a step-phase interferometer type interleaver provides a very wide bandwidth, which is periodic. See, e.g., U.S. Pat. No. 6,587,204 (Hsieh Yung-Chieh). However, the wider bandwidth comes with a larger chromatic dispersion in absolute value at the edge of the pass band due to the very sharp phase transaction. The slope of dispersion within the pass band is positive (as explained below). For purposes of this disclosure, an interleaver that exhibits a positive dispersion slope near the center of the interleaver pass band will be referred to as a P-type interleaver. The dispersion of an optical system results in a different time delay through the system for different wavelengths. To achieve a high data transfer rate optical network, low chromatic dispersion is required to maintain the data fidelity. To reduce the dispersion from the interleaver, one can add a dispersion compensation module (DCM) to introduce an opposite dispersion to that of the interleaver, thereby making the combined dispersion to be near zero in the pass band of the device. However, both the insertion loss of the device and the manufacturing cost are increased in this approach.

It is therefore desirable to provide optical interleavers that have a chromatic dispersion that is near zero in the pass band of the device.

### SUMMARY OF THE INVENTION

It is an object of the present invention to provide a method and apparatus for achieving controlled variable dispersion in an optical interleaver.

It is another object to teach negative and zero dispersion interleavers.

These and other objects will be apparent to those skilled in the art based on the teachings herein.

The present invention teaches two types of step-phase variable dispersion step-phase interferometers for use as optical interleavers. This disclosure enables low dispersion interleavers without using a dispersion compensation module (DCM). The N-type interleaver has a negative dispersion slope near the center of the pass band. The Z-type interleaver has a dispersion that is close to zero within the pass band. The P-, N- and Z-type interleavers shown herein can be arranged in various systems to produce low dispersion optical networks.

For a P-type interleaver the cavity length of the linear etalon cavity must equal half that of the nonlinear cavity. The tolerance for the cavity length variation should be less than ¼ of the wavelength of light Such a tolerance is attainable with the use of a device such as an optical path length tuner. The phase of light reflected from a linear cavity is linearly proportional to the light frequency. A linear cavity will not contribute to the interleaver's dispersion, since the phase's second derivative to the frequency is zero. In contrast, the optical phase of light reflected from a non-linear cavity is a non-linear function, and contributes to the dispersion slope of a P-type interleaver.

The non-linear phase etalons in the N- and Z-type interleavers taught herein contribute to the device dispersion. The N-Type interleaver is similar to the P-type interleaver, except that the linear cavity length is 1.5 times that of non-linear cavity. The Z-type interleaver includes two non-linear cavities (etalons), one in each arm. These cavities are out of phase with each other such that the net dispersion is close to zero. The interleavers taught herein are provided with a wedged AR-pair to avoid ghost reflections from the AR-coating surfaces.

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1 shows a positive dispersion slope interleaver (P-type).

FIG. 2 shows the power spectrum of a 50 GHz/100 GHz interleaver in one of the output ports.

FIG. 3 shows the group delay of a 50 GHz/100 GHz interleaver in one of the output ports.

FIG. 4 shows the dispersion of a 50 GHz/100 GHz interleaver in one of the output ports.

FIG. 5 shows a negative dispersion slope interleaver (N-type).

FIG. 6 shows the power spectrum for one of the output ports for an N-type interleaver.

FIG. 7 shows the group delay for one of the output ports for an N-type interleaver.

FIG. 8 shows the dispersion for one of the output ports for an N-type interleaver.

FIG. 9 shows a zero-dispersion interleaver (Z-type).

FIG. 10 shows the power spectrum for one of the output ports for a Z-type interleaver.

FIG. 11 shows the group delay for one of the output ports for a Z-type interleaver.

FIG. 12 shows the dispersion for one of the output ports for a Z-type interleaver.

FIG. 13 shows a P-type interleaver with a wedged pair to avoid ghost reflections.

FIG. 14 shows an N-type interleaver with a wedged AR-pair to avoid ghost reflections.

FIG. 15 shows a Z-type interleaver with a wedged AR-pair to avoid ghost reflections.

### DETAILED DESCRIPTION OF THE INVENTION

The present invention teaches variable dispersion step-phase interferometers. Two different types of step-phase interleavers are taught in this disclosure. By properly using them, one can achieve low dispersion without using a dispersion compensation module (DCM). The first one is herein referred to as an N-type interleaver, which has a negative dispersion slope near the center of the pass band. In an optical network, cascading an N-type and a P-type interleaver in a pair produces a net dispersion that becomes close to zero. The second proposed interleaver is herein referred to as a Z-type interleaver, which has a dispersion that is close to zero within the pass band. The P-, N- and Z-type interleavers shown herein can be arranged in various systems to produce low dispersion optical networks.

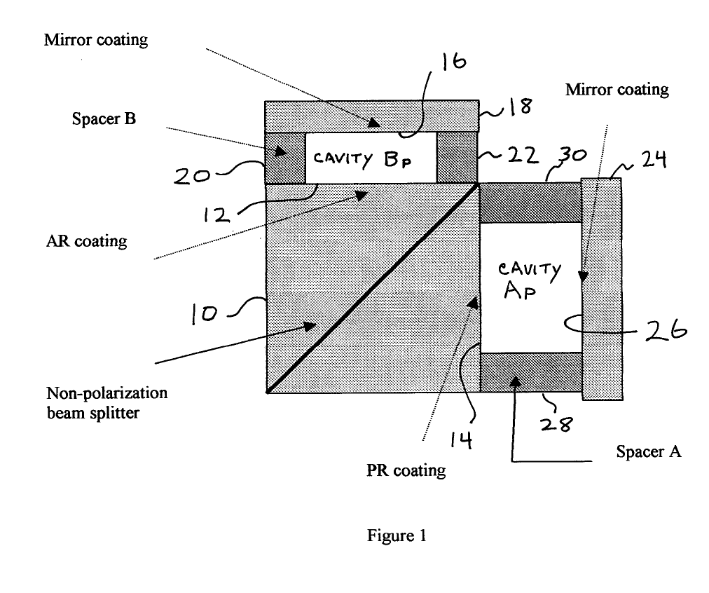

FIG. 1 shows a typical step-phase interleaver, which is described in detail in U.S. Pat. No. 6,587,204, incorporated herein by reference. The cavity at the right hand side of the un-polarized beam splitter (UBS) 10 is twice as long as the cavity above the UBS. In the figure, the topside 12 of the cube is AR coated; the right-hand side 14 of the cube is PR coated to be first surface of a non-linear phase generator. Extra piece 24, having a first surface 26 that is mirror coated is separated from surface 14 by spacers 28 and 30. The mirror-coated surface 16 on the topside of cube 10 is the surface of an extra piece 18 separated from the cube by spacers 20 and 22. The opening between right-hand side 14 and surface 26 is referred to herein as Cavity A_{P}. The opening between topside 12 and mirror-coated surface 16 is referred to herein as Cavity B_{P}. Successful operation of this embodiment requires that the length of Cavity A_{P}=2 times that of Cavity B_{P}. That is, for a P-type interleaver, the cavity length of Cavity B_{P} must equal half that of Cavity A_{P}. The tolerance for the cavity length variation should be less than ¼ of the wavelength of light Such a tolerance is attainable with the use of a device such as an optical path length tuner, as taught in U.S. Pat. No. 6,816,315, incorporated herein by reference, which is also useful in the other devices taught herein.

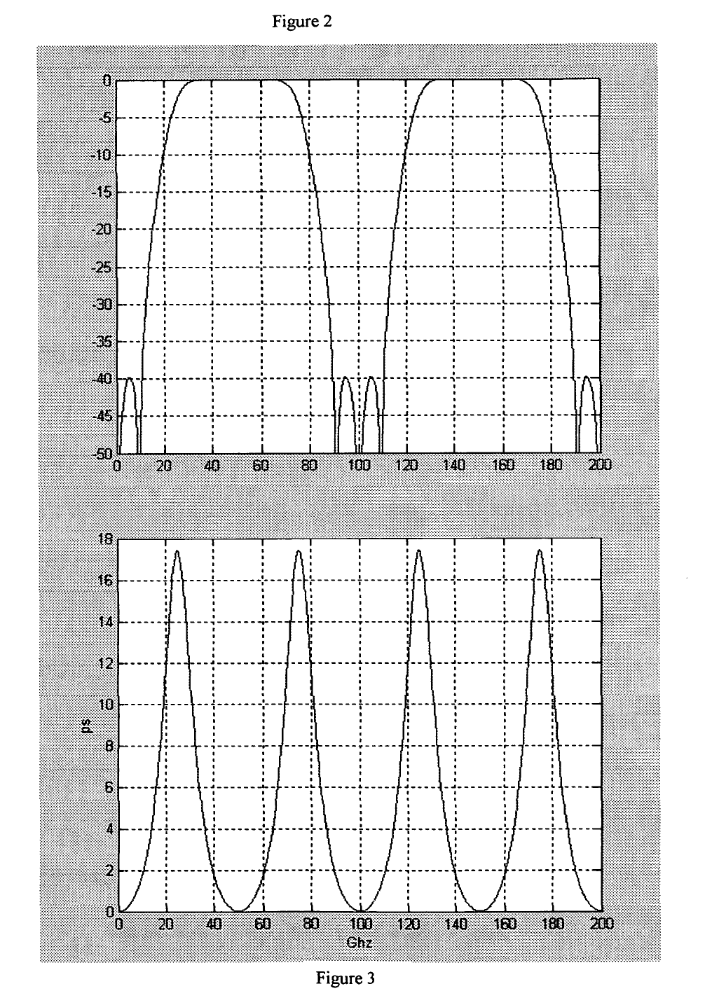

FIGS. 2, 3 and 4 show the power spectrum, group delay and dispersion, respectively, of a 50 GHz/100 GHz interleaver in one of the output ports. In this case, the FSR (free-spectral range) of cavity A_{P} and B_{P} are 50 GHz and 100 GHz respectively. The PR coating at the long cavity (right arm), in one embodiment, is set at 14%. In this example, the pass band is centered at 50 GHz and 150 GHz. Typically, the pass band is defined as +/−10 GHz from the center of the ITU grid. In this case, the pass band is the frequency range from 40 GHz to 60 GHz and from 140 GHz to 160 GHz. As shown in FIG. 1, since surface 12 is AR-coated, the top cavity (Cavity BP) is a linear cavity, which means that the phase of light reflected from such a cavity is linearly proportional to the light frequency. By definition, such a linear cavity will not contribute to the interleaver's dispersion, since the phase's second derivative to the frequency is zero. In contrast, since surface 14 is coated with a partially reflective film, relatively to frequency, the optical phase of light reflected from this cavity is a non-linear function. Therefore, only Cavity A_{P} contributes to the dispersion slope of a P-type interleaver.

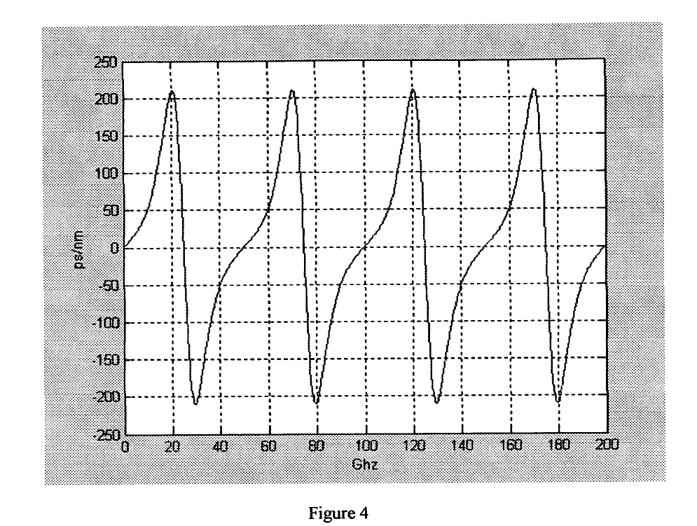

For a non-linear cavity, the group delay is a periodic function of frequency, as shown in FIG. 3. At frequencies where the group delay reaches its peak value, the cavity is in resonance. The corresponding frequencies are called resonance frequencies. As an example from FIG. 3, the resonance frequencies are 25 GHz, 75 GHz, 125 GHz and 175 GHz Notice that the separation between two adjacent resonance frequencies is 50 GHz, which is the FSR of Cavity Ap. Referring to the power spectrum shown in FIG. 2, since the resonance occurs in the 3-dB points, right at the edge of pass-band, we refer to the resonance frequencies of a P-type interleaver as being in the “edge”. Since the dispersion is the derivative of the group delay, at resonance frequencies, the dispersion has a negative slope and equals zero (see FIG. 4). The dispersion slope near the center of the pass band is positive (from −50 ps/nm to 50 ps/nm); therefore, this interleaver is herein referred to as a P-type interleaver.

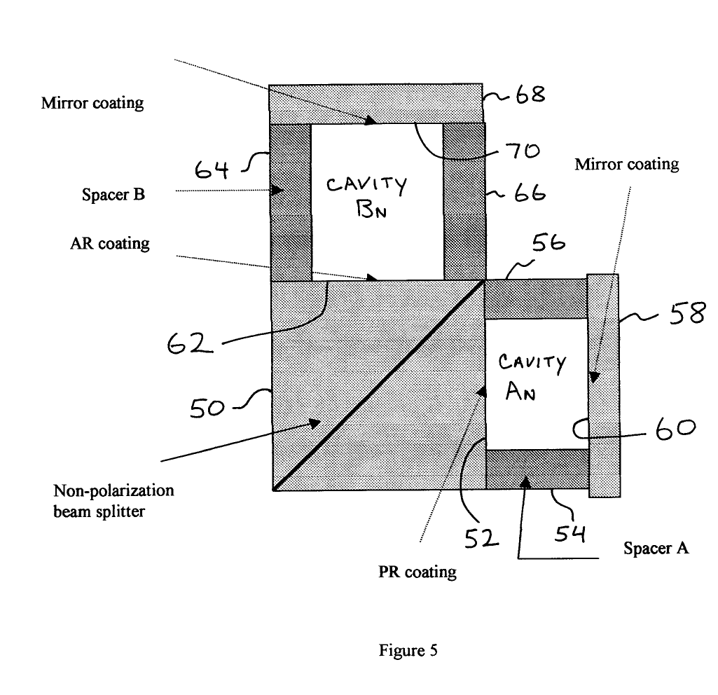

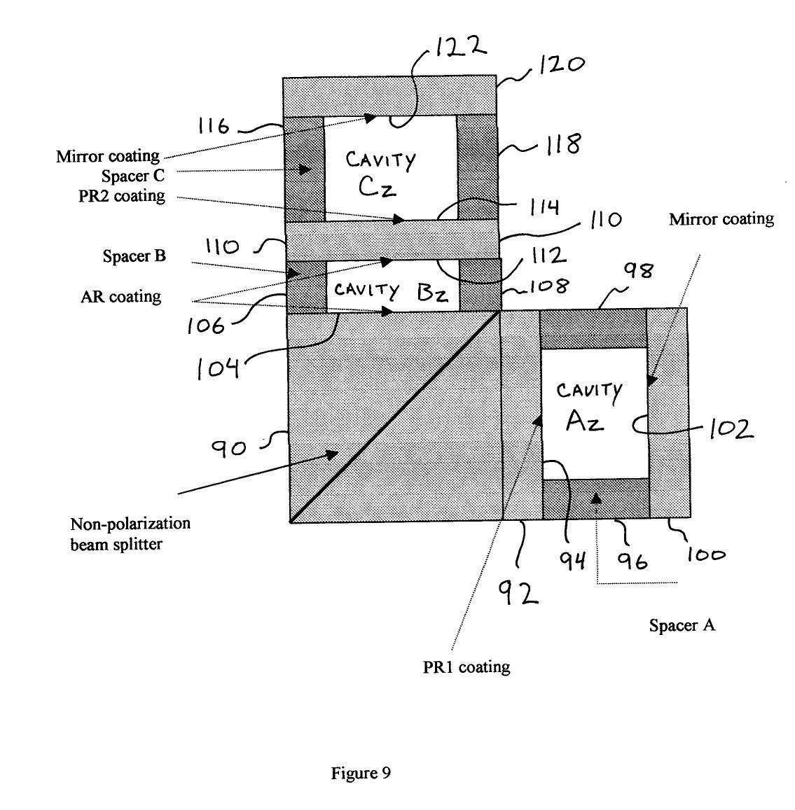

FIGS. 5 and 9 show the structures of an N-type and a Z-type step-phase interleaver, respectively. For the same reasons as discussed above, the non-linear phase etalons in the devices contribute to the dispersion of a step-phase interleaver.

The N-Type interleaver of FIG. 5 includes a non-polarizing beam splitter 50 with a PR coated right side 52. Spacers 54 and 56 support a mirror piece 58 with a mirror surface 60. The space between PR coated right side 52 and mirror surface 60 is herein referred to as Cavity A_{N}. Beam splitter 50 includes a top side 62 that is AR coated. Spacers 64 and 66 support a mirror piece 68 with a mirror surface 70. The space between the AR coated top side 62 and the mirror coated surface 70 is herein referred to as Cavity B_{N}. For an N-type interleaver, the resonance frequency of the etalon is aligned to the center of the pass band and the cavity length of Cavity B_{N} must be equal to 1.5 times that of Cavity A_{N}. The tolerance for the cavity length variation should be less than ¼ of the wavelength of light. Such a tolerance is attainable with the use of a device such as an optical path length tuner, as taught in U.S. Pat. No. 6,816,315.

The Z-type interleaver shown in FIG. 9 includes a non-polarizing beam splitter 90 with an added right side piece 92 that has a PR coated right side 94. Spacers % and 98 support a mirror piece 100 with a mirror surface 102. The space between PR coated right side 94 and mirror surface 102 is herein referred to as Cavity A_{Z}. Beam splitter 90 includes a top side 104 that is AR coated. Spacers 106 and 108 support a piece 110 with a bottom surface 112 that is AR coated and a top surface 114 that is PR coated. The space between the AR coated top side 104 and the AR coated surface 112 is herein referred to as Cavity B_{Z}. Spacers 116 and 118 support mirror piece 120, which has a mirror coated surface 122. The space between PR coated surface 114 and mirror coated surface 122 is herein referred to as Cavity C_{Z}. To fabricate a Z-Type interleaver, there must be two non-linear cavities (A_{Z} and C_{Z}), one in each arm. It is also necessary that the two non-linear cavities be out of phase such that the net dispersion is close to zero. The terms “out of phase” means that the resonance frequency of Cavity A_{Z} and Cavity C_{Z} are off by half of the FSR. For a 50 GHz/100 GHz interleaver, the FSR of Cavity A_{Z} and C_{Z} both are 50 GHz; therefore, “out of phase” means they are off by 25 GHz. In other words, the resonance frequency of one of cavity is at the center of the pass band and the resonance frequency of the other cavity is at the edge. Under this condition, at the center of pass band, the group delay of Cavity A_{Z} has a positive curvature and that of cavity C has negative curvature. When adding these two curves together, the net group delay curve is near zero at the pass band. This is the mechanism of making a “zero” dispersion interleaver. Basically, what is required is that the two non-linear cavities are offset by half of the FSR such that their dispersion is cancelled.

Table 1 lists the thickness of the spacers used in various types of interleavers. Table 2 shows the resonance frequency of Cavities A_{Z} and Cavity C_{Z} (for Z-type interleaver).

TABLE 1
Exemplary spacer thickness for various types of interleavers

| | P-type | N-type | Z-type |
|---|---|---|---|
| 100 GHz/ | A = 1.499 mm | A = 1.499 mm | A = 1.499 mm |
| 200 GHz | B = 0.5A | B = 1.5A | B = 0.5A |
| | | | C = A |
| 50 GHz/ | A = 2.998 mm | A = 2.998 mm | A = 2.998 mm |
| 100 GHz | B = 0.5A | B = 1.5A | B = 0.5A |
| | | | C = A |

TABLE 2
Alignment of the Resonance frequency of Cavities A and C

| | P-type | N-type | Z-type |
|---|---|---|---|
| Cavity A | Edge | Center of pass band | Center of pass band |
| Cavity C | NA | NA | Edge |

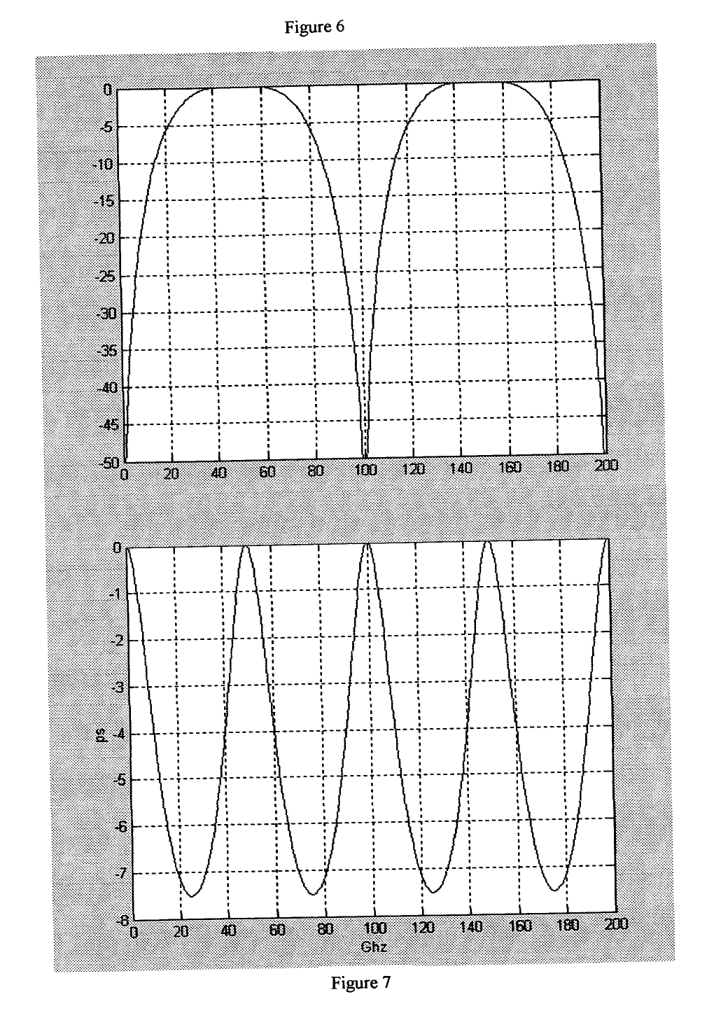

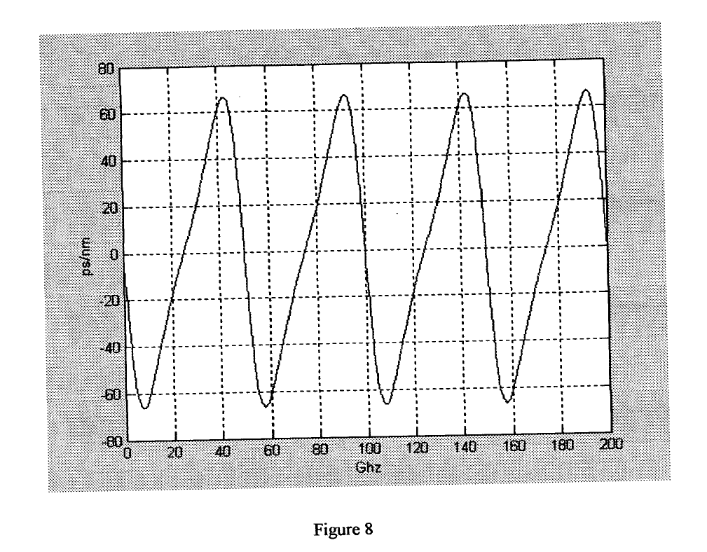

FIGS. 6, 7 and 8 shows the power spectrum, group delay and dispersion for one of the output ports for an N-type interleaver. In this example, the PR coating is 3.3%. It can be seen that the dispersion has a negative slope in the pass band.

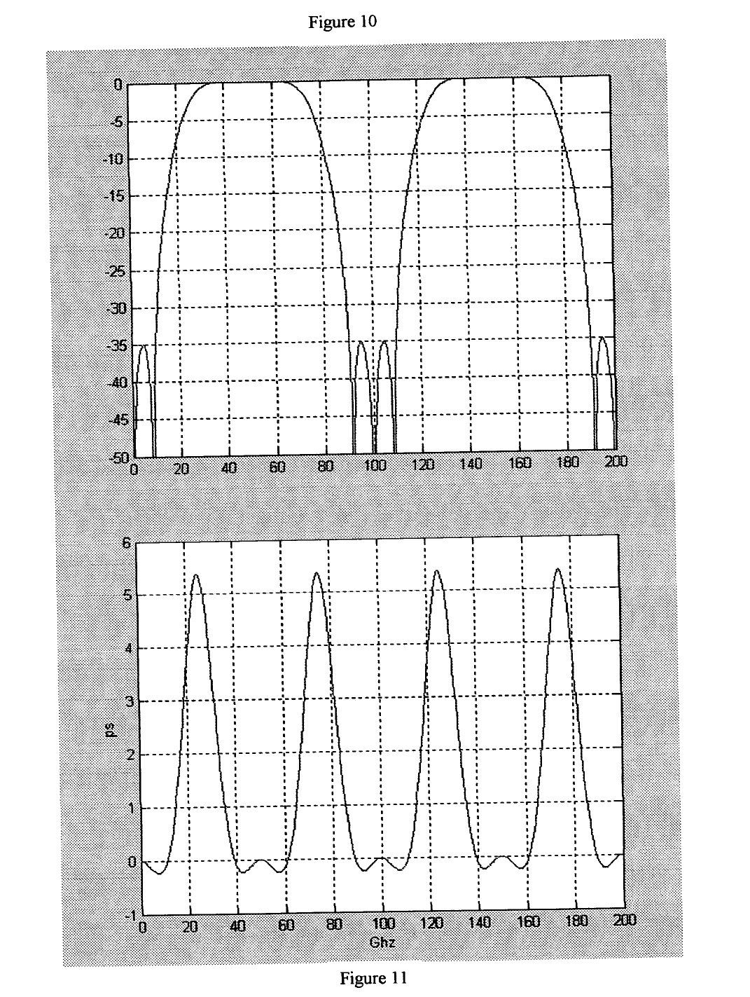

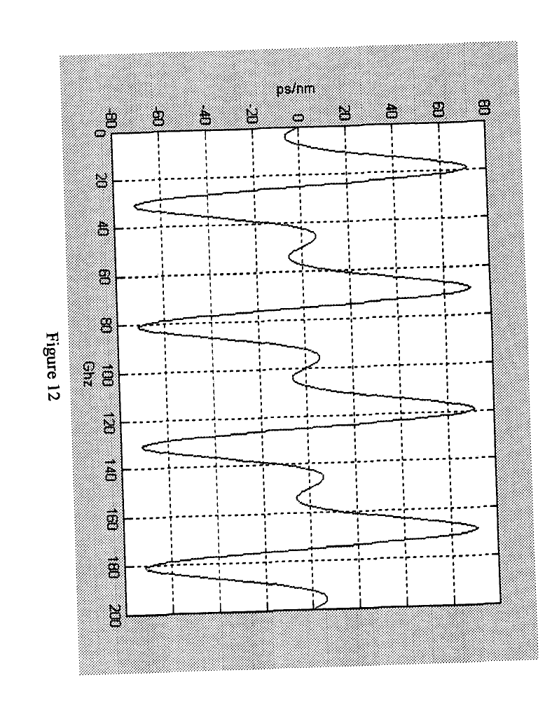

FIGS. 10, 11 and 12 shows the power spectrum and dispersion for one of the output ports for a Z-type interleaver, where (PR1, PR2)=(1%, 5%). The dispersion within the pass band is +/−10 ps/nm, which has reduced by a factor of 5 compared to the results shown in FIG. 3.

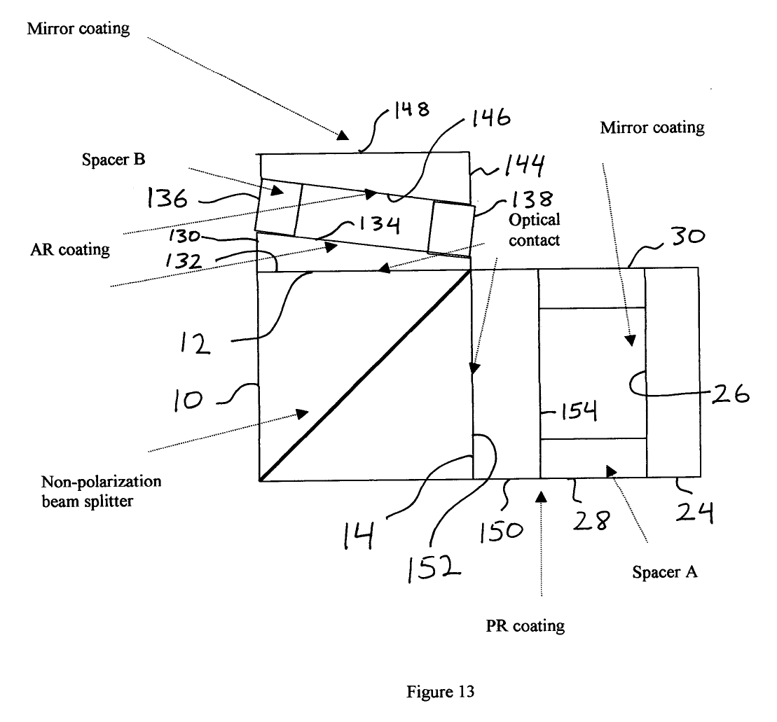

FIG. 13 shows a P-type interleaver with a wedged AR-pair to avoid ghost reflections from the AR-coating surfaces. Some elements in this figure are identical to certain elements of FIG. 1 and are numbered accordingly. However, the right side 14 is not PR coated, and makes optical contact to side 152 of piece 150. An index-matched glue can be used to make the contact Piece 150 has a right side 154 that is PR coated. Further, the top surface 12 is not AR coated. An optical wedge 130 includes a bottom surface 132 that is in optical contact with top surface 12. The top surface 134 of the optical wedge 130 in AR coated. Spacers 136 and 138 are placed onto the wedge 130 and support another optical wedge 144, which includes a first surface 146 that is AR coated, and includes a second surface 148 that is mirror coated.

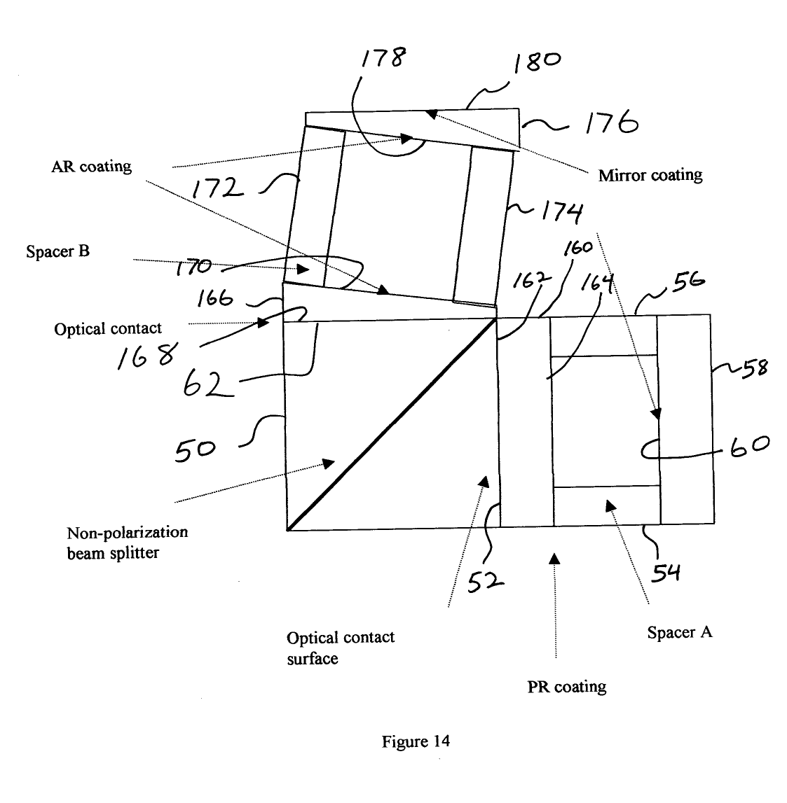

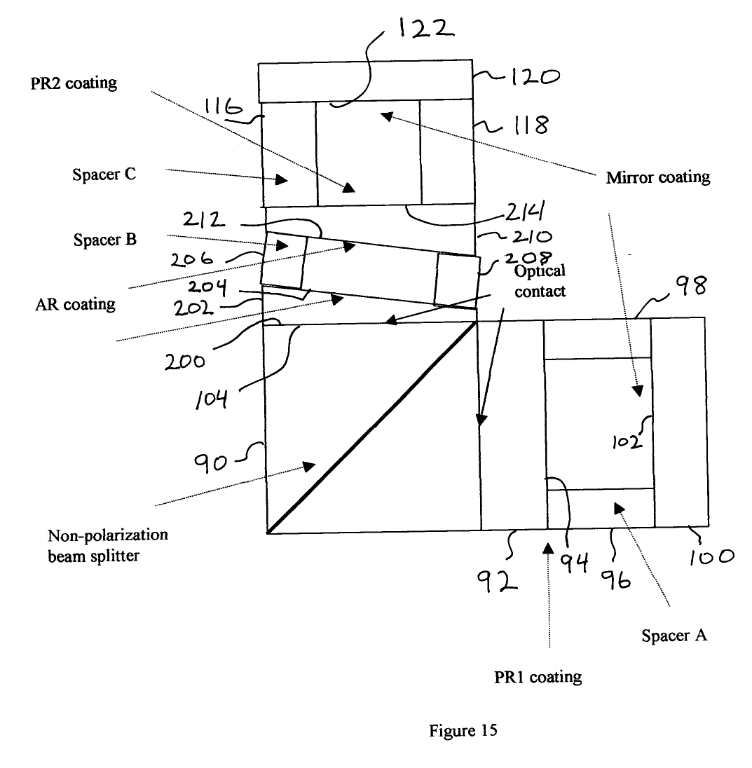

FIG. 14 shows an N-type interleaver with a wedged AR-pair to avoid ghost reflections from the AR-coating surfaces. Some elements in this figure are identical to certain elements of FIG. 5 and are numbered accordingly. To the right of beam splitter 50 is piece 160, which includes a surface 162 that makes optical contact with surface 52. Surface 164 of piece 160 is PR coated. An optical wedge 166 includes a surface 168 that makes optical contact with uncoated surface 62 of beam splitter 50. The top surface 170 of wedge 166 supports spacers 172 and 174, which support another optical wedge 176. An AR coating is located on surface 178 and a mirror coating is on surface 180.

FIG. 14 shows a Z-type interleaver with a wedged AR-pair to avoid ghost reflections from the AR-coated surfaces. Some elements in this figure are identical to certain elements of FIG. 9 and are numbered accordingly. An uncoated surface 200 of optical wedge 202 makes optical contact with the top (104) of the beam splitter 90. The second surface 204 is AR coated. Spacers 206 and 208 support a second optical wedge 210, which includes a first surface 212 that is AR coated and a second surface 214 that is PR coated.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

1. A variable dispersion optical step-phase interferometer, comprising:
a beam splitter to separate an incident beam of light into a first beam of light and a second beam of light;
a first non-linear phase generator (NLPG) operatively positioned to reflect said first beam of light to produce a first reflected beam; and
means for reflecting said second beam of light such that (i) the frequency dependence of the phase difference between said first reflected beam and said second reflected beam has a step-like function and (ii) said first reflected beam and said second reflected beam interfere with one another to produce an output beam having a dispersion slope that is negative or about zero.

2. The interferometer of claim 1, wherein said beam splitter comprises an un-polarized beam splitter.

3. The interferometer of claim 2, wherein said first NLPG comprises a non-linear phase etalon (NLPE).

4. The interferometer of claim 3, wherein said means for reflecting said second beam of light comprises a linear phase etalon (LPE).

5. The interferometer of claim 4, wherein said first NLPE comprises a NLPE cavity length and wherein said LPE comprises a LPE cavity length, wherein said LPE cavity length is 1.5 times the length of said NLPE cavity length such that said dispersion slope is negative.

6. The interferometer of claim 5, wherein said NLPE comprises a first optical path length tuner, wherein said LPE comprises a second optical path length tuner.

7. The interferometer of claim 3, wherein said means for reflecting said second beam of light comprises a second NLPG.

8. The interferometer of claim 7, wherein said second NLPG comprises a second non-linear phase etalon (NLPE).

9. The interferometer of claim 8, wherein said NLPE is out of phase with said second NLPE such that said dispersion slope is about zero.

10. The interferometer of claim 8, wherein the cavity length of said NLPE and the cavity length of said second NLPE are offset with respect to each other by half of their respective FSR such that their respective dispersion is canceled.

11. The interferometer of claim 10, wherein said NLPE comprises a first optical path length tuner, wherein said second NLPE comprises a second optical path length tuner.

12. The interferometer of claim 4, wherein said first NLPE comprises a NLPE cavity length and wherein said LPE comprises a LPE cavity length, wherein said NLPE cavity length is 1.5 times the length of said LPE cavity length such that said dispersion slope is positive, wherein said LPE comprises a wedged AR-pair to avoid ghost reflections.

13. The interferometer of claim 5, wherein said LPE comprises a wedged AR-pair to avoid ghost reflections.

14. The interferometer of claim 10, further comprising a wedged AR-pair to avoid ghost reflections, wherein said AR-pair is operatively place in said first beam of light between said non-polarizing beam splitter and said second NLPE.

15. The interferometer of claim 2, wherein said un-polarized beam splitter comprises an internal beam splitting coating such that Ψ_{S}_{_{R}}−Ψ_{S}_{_{R′}}=Ψ_{PR}−Ψ_{PR′}.

16. The interferometer of claim 2, wherein said un-polarized beam splitter comprises an internal beam-splitting coating that affects the phase of said first beam and said second beam such that (Ψ_{S}_{_{R}}−Ψ_{S}_{_{R′}})−(Ψ_{PR-Ψ}_{PR′}) is minimized.

17. The interferometer of claim 2, wherein said un-polarized beam splitter comprises an internal beam-splitting coating that affects the phase of said first beam and said second beam such that (Ψ_{S}_{_{R}}−Ψ_{S}_{_{R′}})−(Ψ_{P}_{_{R}}−Ψ_{P}_{_{R′}}) is approximately zero.

18. The interferometer of claim 2, wherein said un-polarized beam splitter comprises a symmetrical internal beam-splitting coating.

19. A method for interleaving frequencies of light, comprising:
separating an incident beam of light into a first beam of light and a second beam of light;
reflecting said first beam of light with a first non-linear phase generator (NLPG) to produce a first reflected beam; and
reflecting said second beam of light such that (i) the frequency dependence of the phase difference between said first reflected beam and said second reflected beam has a step-like function and (ii) said first reflected beam and said second reflected beam interfere with one another to produce an output beam having a dispersion slope that is negative or about zero.

20. The method of claim 19, wherein the step of separating is carried out with an un-polarized beam splitter, wherein said first NLPG comprises a non-linear phase etalon (NLPE), wherein said means for reflecting said second beam of light comprises a linear phase etalon (LPE), wherein said first NLPE comprises a NLPE cavity length and wherein said LPE comprises a LPE cavity length, wherein said LPE cavity length is 1.5 times the length of said NLPE cavity length such that said dispersion slope is negative.

21. The method of claim 19, wherein the step of separating is carried out with an un-polarized beam splitter, wherein said means for reflecting said second beam of light comprises a second NLPG, wherein said second NLPG comprises a second non-linear phase etalon (NLPE), wherein said NLPE is out of phase with said second NLPE such that said dispersion slope is about zero.

22. The method of claim 19, wherein the step of separating is carried out with an un-polarized beam splitter, wherein said means for reflecting said second beam of light comprises a second NLPG, wherein said second NLPG comprises a second non-linear phase etalon (NLPE), wherein the cavity length of said NLPE and the cavity length of said second NLPE are offset with respect to each other by half of their respective FSR such that their respective dispersion is about canceled, such that said dispersion slope is about zero.

23. The method of claim 19, wherein the step of separating is carried out with an un-polarized beam splitter comprising an internal beam splitting coating such that Ψ_{S}_{_{R}}−Ψ_{S}_{_{R′}}=Ψ_{P}_{_{R}}−Ψ_{P}_{_{R′}}.

24. The method of claim 19, wherein the step of separating is carried out with an un-polarized beam splitter comprising an internal beam splitting coating that affects the phase of said first beam and said second beam such that (Ψ_{S}_{_{R}}−Ψ_{S}_{_{R′}})−(Ψ_{P}_{_{R}}−Ψ_{P}_{_{R′}}) is minimized.

25. The method of claim 19, wherein the step of separating is carried out with an un-polarized beam splitter comprising an internal beam splitting coating that affects the phase of said first beam and said second beam such that (Ψ_{S}_{_{R}}−Ψ_{S}_{_{R′}})−(Ψ_{P}_{_{R}}−Ψ_{P}_{_{R′}}) is approximately zero.

26. The method of claim 19, wherein the step of separating is carried out with an un-polarized beam splitter comprising a symmetrical internal beam splitting coating.
